(19) United States
(12) Patent Application Publication
(10) Pub. No.: US 2013/0174454 A1
(43) Pub. Date: Jul. 11, 2013

(54) Head Box Device

(71) Applicant: Sam Paul Bebeau, Dallas, TX (US)

(72) Inventor: Sam Paul Bebeau, Dallas, TX (US)

(21) Appl. No.: 13/733,307

(22) Filed: Jan. 3, 2013

Related U.S. Application Data
(60) Provisional application No. 61/585,504, filed on Jan. 11, 2012.

(51) Int. Cl. G09F 21/02

(52) U.S. Cl. CPC G09F 21/026
USPC 40/586

(57) ABSTRACT

A head box device to be worn over the head of the user may include a first sidewall, a second sidewall which may be connected to the first sidewall, and a top wall which may be connected to the first and second sidewall. The first sidewall, second sidewall or top wall may be formed from a head box material to allow a user to see through the head box device of the present invention either partially or completely and to allow indicia to be printed on the exterior surface of the head box device.

### PRIORITY

The present invention claims priority under 35 USC section 119 and based upon a provisional application with a serial number of No. 61/585,504 which was filed on Jan. 11, 2012.

### FIELD OF THE INVENTION

The present invention relates to an advertising device and more particularly to a head box device for advertisement.

### BACKGROUND

Advertising is an important aspect of business today. Having a unique device to perform the advertising is sometimes just as important as having a unique message.

### SUMMARY

A head box device to be worn over the head of the user may include a first sidewall, a second sidewall which may be connected to the first sidewall, and a top wall which may be connected to the first and second sidewall. The first sidewall, second sidewall or top wall may be formed from a head box material to allow a user to see through the head box device of the present invention either partially or completely and to allow indicia to be printed on the exterior surface of the head box device.

The head box device may include a projection device to project an image on a surface of the head box device.

The head box device may include a front wall being formed from a head box material to allow a user to see through the head box device of the present invention either partially or completely and to allow indicia to be printed on the exterior surface of the head box device.

The head box device may include a back wall being formed from a head box material to allow a user to see through the head box device of the present invention either partially or completely and to allow indicia to be printed on the exterior surface of the head box device.

The head box device may include a circular cross-section.

The head box device may include a ellipse flat back cross-section.

The head box device may include a free-form shape cross-section.

The head box device may include a ellipse shape cross-section.

The head box device may include a rectangle curve side cross-section.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of a head box device of the present invention;

FIG. 2 illustrates a cross-sectional view of the head box device of the present invention;

FIG. 3 illustrates a perspective view of the head box device of the present invention;

FIG. 4 illustrates a cross-sectional view of the head box device of the present invention;

FIG. 5 illustrates a perspective view of the head box device of the present invention;

FIG. 6 illustrates a cross-sectional view of the head box device of the present invention;

FIG. 7 illustrates a side view of the head box device of the present invention;

FIG. 8 illustrates a cross-sectional view of the head box device of the present invention;

FIG. 9 illustrates a perspective view of the head box device of the present invention;

FIG. 10 illustrates a top view of the head box device of the present invention;

FIG. 11 illustrates a side view of the head box device of the present invention;

FIG. 12 illustrates a side view of the head box device of the present invention

FIG. 13 illustrates a side view of the head box device of the present invention;

FIG. 13a illustrates a top view of the head box device of the present invention;

FIG. 14 illustrates a plan view of the head box device of the present invention;

FIG. 15 illustrates an elevation view of the head box of the present invention;

FIG. 16 illustrates a plan view of the head box device of the present invention;

FIG. 17 illustrates a side elevation view of the head box device of the present invention;

FIG. 18 illustrates a back elevation view of the head box device of the present invention;

FIG. 19 illustrates a plan view of the head box device of the present invention;

FIG. 20 illustrates a elevation view of the head box device of the present invention;

FIG. 21 illustrates a plan view of the head box device of the present invention;

FIG. 22 illustrates an elevation view of the head box device of the present invention;

FIG. 23 illustrates an elevation view of the head box device of the present invention;

FIG. 24 illustrates a elevation view of the head box device of the present invention;

FIG. 25 illustrates a plan view of the head box device of the present invention;

FIG. 26 illustrates an elevation view of the head box device of the present invention;

FIG. 27 illustrates a plan view of the head box device of the present invention.

### DETAILED DESCRIPTION

The present invention may be referred to as a Head Dress Image Element aka: (Head Worn Image Displaying Element), and the present invention may be used as a Head Dress/Head Bill Board/Head Sign

The purpose of the present invention is to provide a head worn image displaying element (referred to as a head box device) that can be used to display any item or indicia on the external surfaces of the head worn image displaying element. The head worn image display element may be formed from a trans parent material including Plexiglas, glass, Lexan, acrylic, acetate, plastic, resin, polymer, or any other similar material that can receive an temporarily changeable or permanent film applied or an integral image which may be applied to the exterior outward facing side of the material part of the head worn image displaying element. The imagery can be on the top, only one side or all sides of the head worn image displaying element.

The imagery film or integral image inside the head worn image displaying element material may be transparent or semi transparent to allow the user which may be a person or an animal wearing the head worn element to see through the exterior film applied, or integral image at any openness percentage.

Images and indicia may be print art work, symbols, letters, numbers, graphic, led generated screen, or light projected mediums in any color or non-color.

The shape of the head worn image displaying element may be any shape circular, oval, rectangle, square, cone, triangle, trapezoid, parallelogram , molded, curve to linear, freeform, etc and maybe formed from material being rolled, cut or other processes from materials. The material may be formed thermally from air pressure, or water manipulated. Sharp points which may be formed on the material should be made dull to reduce the potential of the material ability to harm any surrounding people, animals, or objects.

The material may be multiple sectional components joined together by tape, glue adhered, pinned connections, or chemically bonded.

The head worn image displaying element may be any reasonable size to support the image and be supported by the person or animal wearing it.

The head worn image displaying element material may be any color or non color, texture, or pattern.

The bottom of the head worn image displaying element may include an opening on the bottom to allow for the placement of it over the users or some things head. The top of the head worn image displaying element may be opened, may be partially opened, or may be completely closed by any material as the makeup of the head worn image displaying element or card board, foam, core board, plywood, fabric, etc. These tops may be secured by the same joining material as mentioned above in joining head worn image displaying element components of the together.

The head box device of the present invention may be formed from a head box material which may allow a user to see through the head box device of the present invention either partially or completely and may allow indicia which may be advertising to be printed on the exterior surface of the head box device (particularly the sides of the head box device) to allow the user to move without fear of running into objects and yet present advertisements to other individuals within sight of the head box device. The material may be a view through, one way prints which may be perforated white on black vinyl film or could be clear PlastiView or maybe a clear perforated see-through media for inkjet printers. The head box material may be used to form at least one of the sidewall, the front wall, the back wall, the bottom wall or the top wall as described herein below.

The head box device of the present invention may come in various sizes and shapes in order to present advertising.

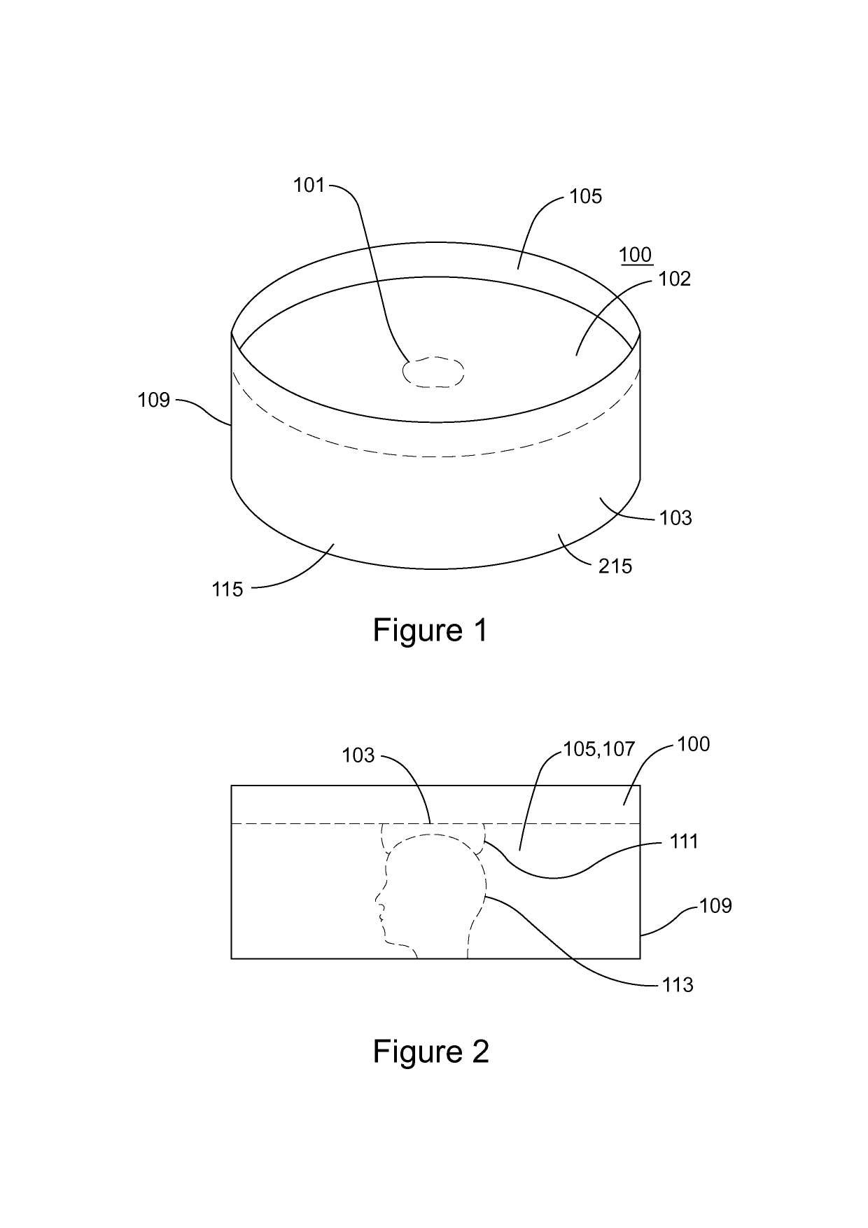

FIG. 1 illustrates a head box device 100 which may include a first curve sidewall 105 which may be convexly curved and a second curved sidewall 107 which may be convexly curved and which may be connected to the first curve sidewall 105 by a pair of opposed edges 109. In addition, the head box device 100 may include a top wall 103 which may be recessed beneath the top edge of the first curve sidewall 105 and which may be permeable in order to be breathable to allow excess heat to escape and the second curved sidewall 107 and may be connected to the first curve sidewall 105 and the second curved sidewall 107 at the periphery of the top wall 103. The interior surface of the top wall 103 may be connected to a head spacer 111 which may be shaped to be adapted to cooperate with the head of the user of the head box device 100. The bottom edge of the first sidewall 105 and the bottom edge of the second sidewall 107 define an opening into a cavity 115.

FIG. 2 illustrates the head box device 100 and illustrates the head spacer 111, the user 113, the first and second sidewall 105, 107, the top wall 103 and the edge 109.

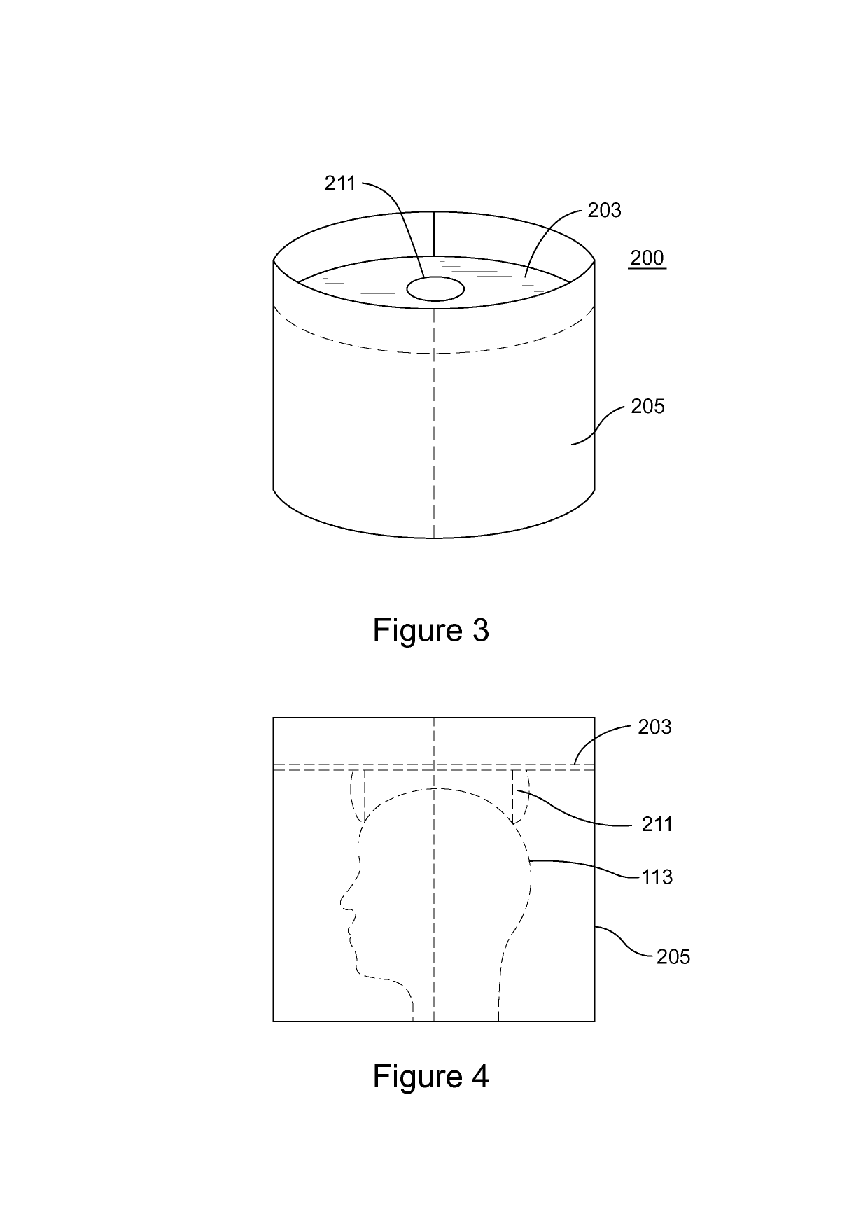

FIG. 3 illustrates a head box device 200 which may be a substantial cylinder and which may include a curved sidewall 205 which may be convexly curved. In addition, the head box device 200 may include a top wall 203 which may be recessed beneath the top edge of the curved sidewall 205 and which may be permeable in order to be breathable to allow excess heat to escape and may be connected to the curved sidewall at the periphery of the top wall 203. The interior surface of the top wall 203 may be connected to a head spacer 211 which may be shaped to be adapted to cooperate with the head of the user 113 of the head box device 200. The bottom edge of the sidewall may define an opening into a cavity 215.

FIG. 4 illustrates the head box device 200 and illustrates the head spacer 211, the user 113, the curved sidewall 205, and the top wall 203.

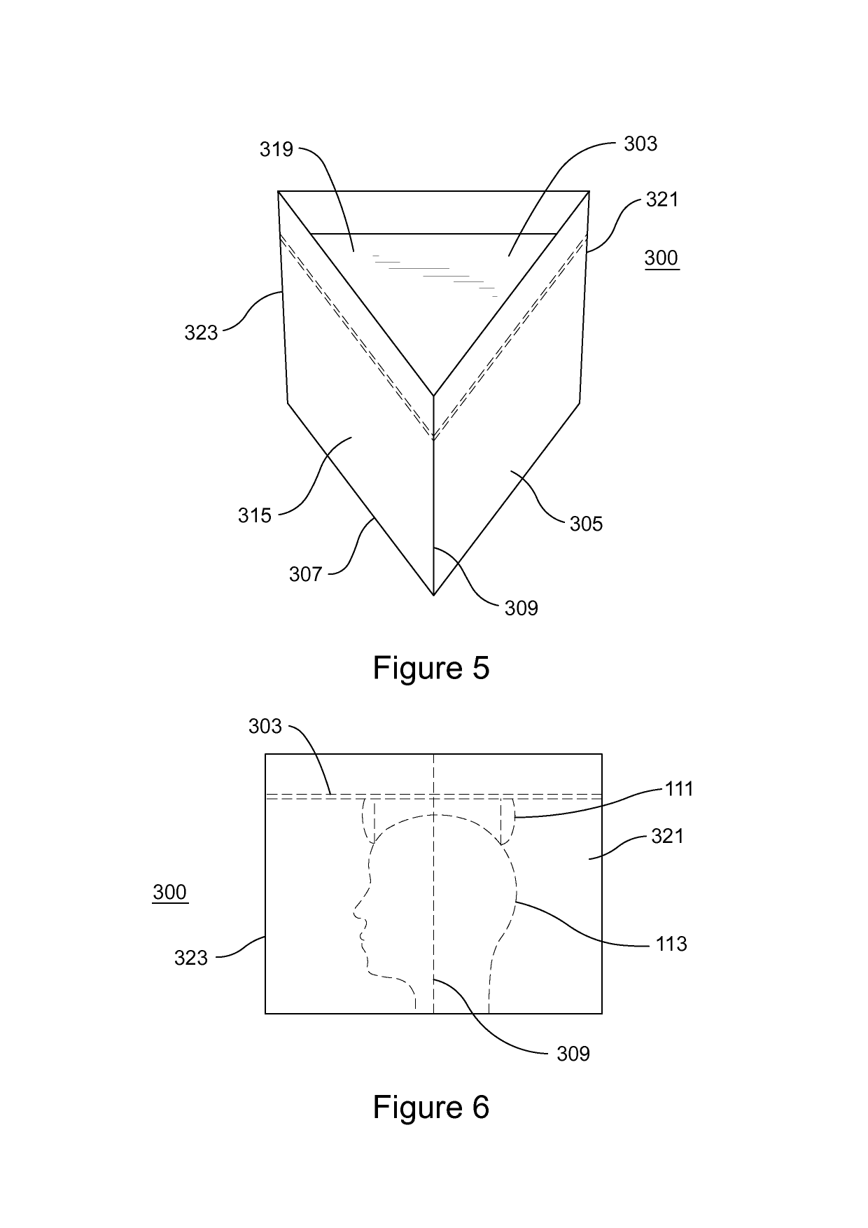

FIG. 5 illustrates a head box device 300 which may be pie shaped (a triangular cross-section) and which may include a first angled sidewall 305 which may be a rectangle and a second angled sidewall 307 which may be a rectangle and which may be connected to the first angled sidewall 305 at an acute angle by an first edge 309. The head box device 300 may include a third angled sidewall 319 which may be a rectangle and which may be connected to the first angled sidewall 305 at an acute angle and at a second edge 321 and which may be connected to the second angled sidewall 307 at an acute angle at a third edge 323. In addition, the head box device 300 may include a top wall 303 which may be recessed beneath the top edge of the first angled sidewall 305, the second angled sidewall 307 and the third angled sidewall 319 and which may be permeable in order to be breathable to allow excess heat to escape and may be connected to the first angled sidewall 305, the second angled sidewall 307 and the third angled sidewall 319 at the periphery of the top wall 303. The interior surface of the top wall 103 may be connected to a head spacer 111 which may be shaped to be adapted to cooperate with the head of the user of the head box device 30 is zero. The bottom edge of the first angled sidewall 305, the bottom edge of the second angled sidewall 307, and the third angled sidewall 319 define an opening into a cavity 315.

FIG. 6 illustrates the head box device 300 and illustrates the head spacer 111, the user 113, the first second and third sidewall 305, 307, 319, the top wall 303 and the first, second and third edge 309, 321, 323.

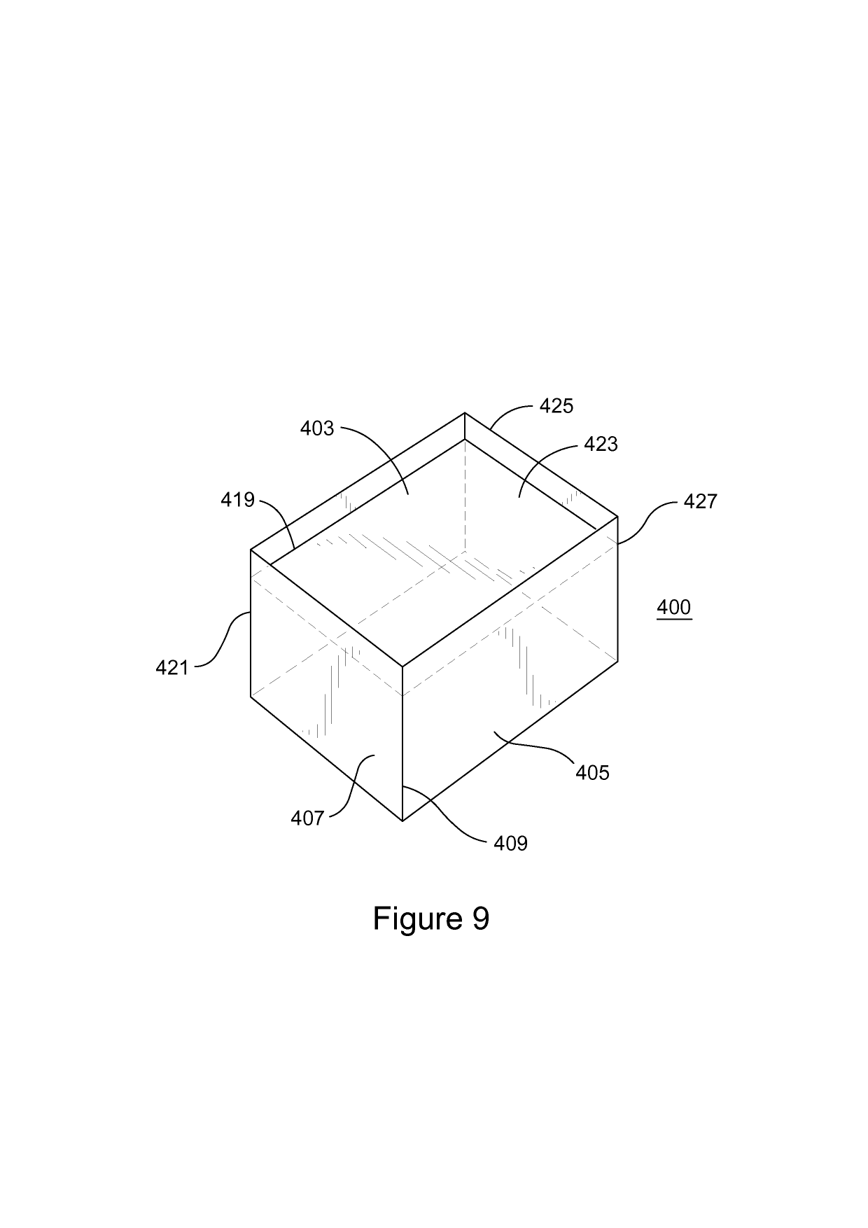

FIG. 9 illustrates a head box device 400 which may be rectangular shaped (a box cross-section) and which may include a first sidewall 405 which may be a rectangle and a second sidewall 407 which may be a rectangle and which may be connected to the first sidewall 405 at a substantially perpendicular angle by an first edge 409. The head box device 400 may include a third sidewall 419 which may be a rectangle and which may be connected to the second sidewall 407 at substantially perpendicular angle and at a second edge 421. The head box device 400 may include a fourth sidewall 423 which may be a rectangle and which may be connected to the third sidewall 419 at substantially perpendicular angle and at a third edge 425 and which may be connected to the first sidewall 405 at substantially perpendicular angle at a fourth edge 427. In addition, the head box device 300 may include a top wall 403 which may be recessed beneath the top edge of the first sidewall 405, the second sidewall 407, the third sidewall 419, and the four sidewall 423 and which may be permeable in order to be breathable to allow excess heat to escape and may be connected to the first sidewall 405, the second sidewall 407, the third sidewall 419 and the fourth sidewall 423 at the periphery of the top wall 303. The interior surface of the top wall 103 may be connected to a head spacer 111 which may be shaped to be adapted to cooperate with the head of the user of the head box device 300. The bottom edge of the first sidewall 405, the bottom edge of the second angled sidewall 407, the bottom edge of the third sidewall 319 and the bottom edge of the fourth sidewall 423 define an opening into a cavity 415.

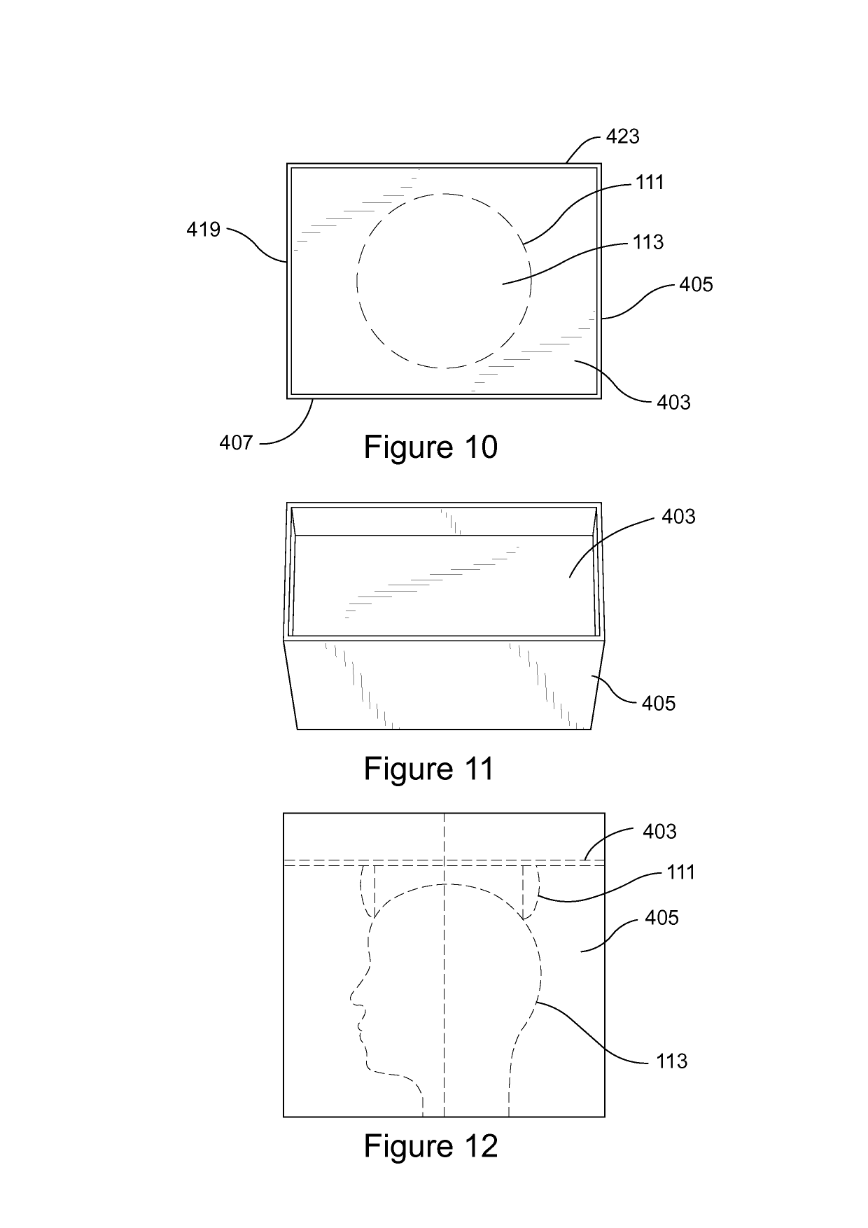

FIG. 10 illustrates the head box device 400 and illustrates the head spacer 111, the user 113, the first second third and fourth sidewall 405, 407, 419, 423 and the top wall 403.

FIG. 11 illustrates a side view of the head box device 400 and illustrates one of the first, second, third, and fourth sidewall 405, 407, 419, 423 and a top wall 403.

FIG. 12 illustrates a side view of the head box device 400 and illustrates one of the first, second, third, and fourth sidewall 405, 407, 419, 423 and a top wall 403.

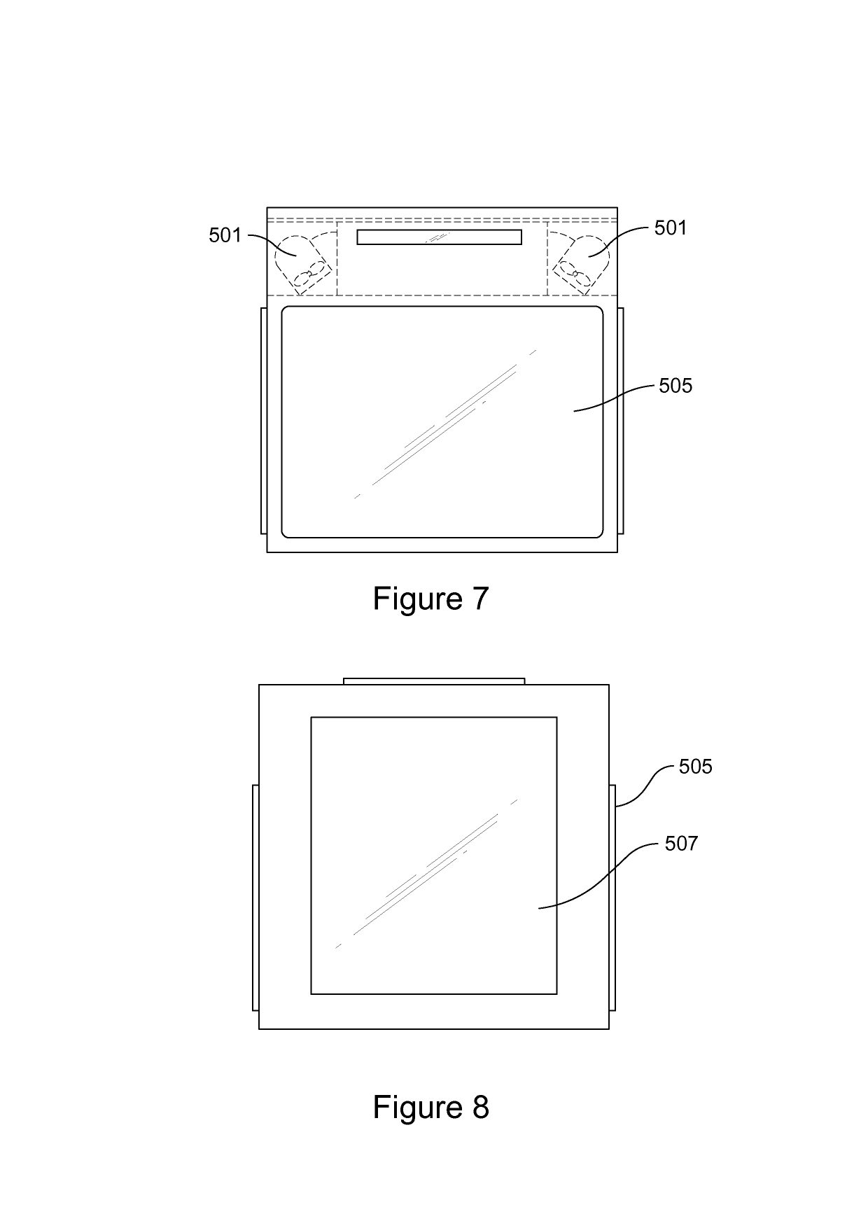

FIG. 7 and FIG. 8 illustrate accessories for technology and comfort which may be employed on any of the side walls described herein. FIG. 7 illustrates a pair of opposing ventilation fans 501 which may be positioned between the top wall and the top edge of the sidewall and may be battery-powered which may be rechargeable A C or rechargeable with a solar panel which may be positioned with the top wall. In addition, FIG. 7 illustrates a light display 503 which may be LED or glow lighting which may be powered by the batteries described above. The light display 503 may be positioned on the sidewall between the upper edge of the sidewall and the top wall. FIG. 7 illustrates a display for video 505 which may be positioned on the sidewall between the lower edge of the sidewall and the top wall. The display for video 505 may be positioned on each sidewall with the exception of a single sidewall which may be used for navigation by the user.

FIG. 8 illustrates a sidewall including a solar panel 507 which may be used to collect solar energy and convert the solar energy to electricity to power the above-mentioned batteries. The area around the solar panel 507 may include permeable material so that the user can properly breathe.

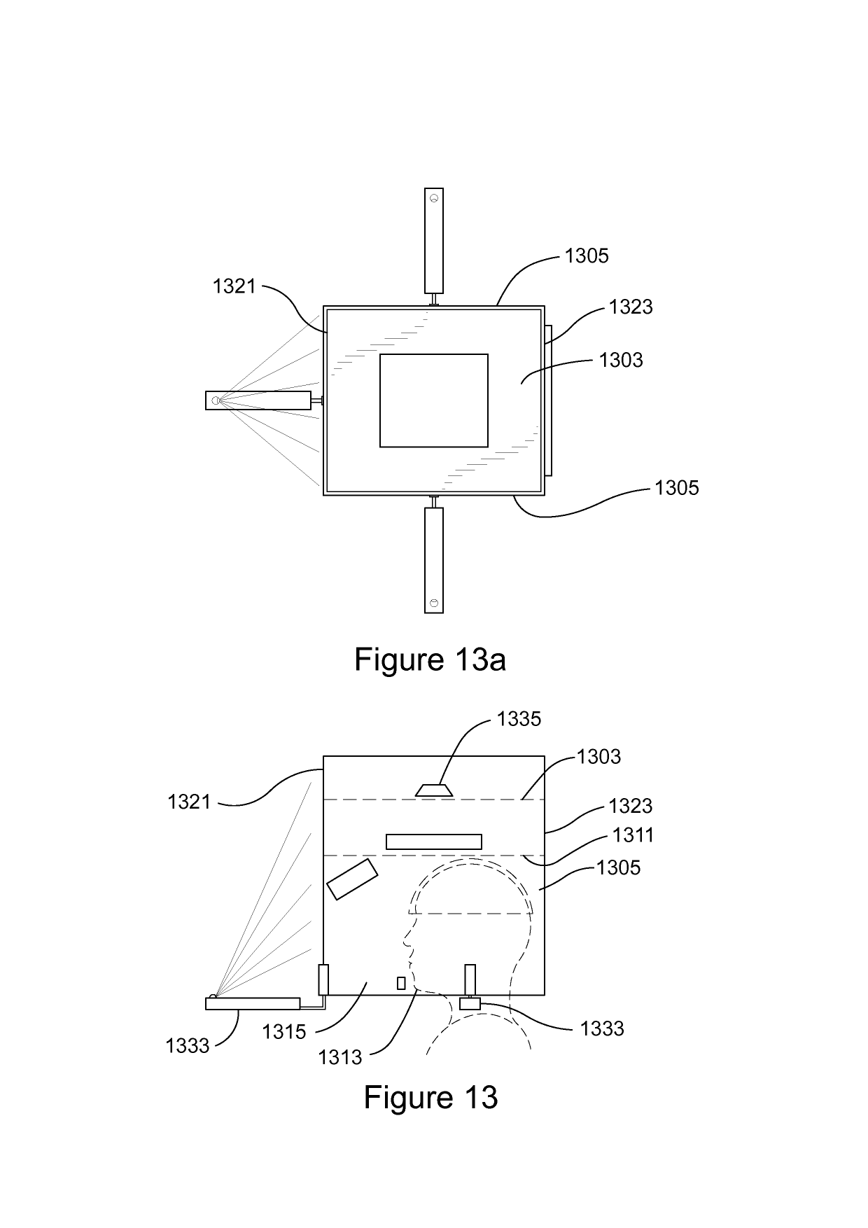

FIGS. 13 and 13a illustrates a head box device 1300 which may include a pair of opposing sidewalls 1305, a front wall 1321 which may be connected to the side walls 1305 and a back wall 1323 which may be connected to the side walls 1305. In addition, the head box device 1300 may include a top wall 1303 which may be recessed beneath the top edge of the sidewall 1305, the front wall 1321 and the back wall 1323 and which may be permeable in order to be breathable to allow excess heat to escape. The head box device 1300 may include a head spacer 1311 which may be shaped to be adapted to cooperate with the head of the user of the head box device 1300. The bottom edge of the sidewall 1305 and the bottom edge of the front wall 1321 and the back wall 1323 may define an opening into a cavity 1315.

The bottom edge of the sidewall 1305 and the bottom edge of the front wall 1321 and the back wall 1323 may be connected to a bracket 1331 which may hold a projection device 1333 to project light images to the sidewall 1305, the front wall 1321 and the back wall 1323. The projection device 1333 may be an iPhone, smart phone, or other light emitting device LED. The projection device 1330 may receive the light images to be projected or may store the light images to be projected. The top wall 1303 may be connected to a speaker device 1335 in order to broadcast audio to the user 1313 and the head spacer 1311 may be connected to a battery pack 1337 to power the various devices of the head box device 1300. A cooling fan 1339 may be mounted in the cavity 1315 to provide ventilation and cool air to the user 1313.

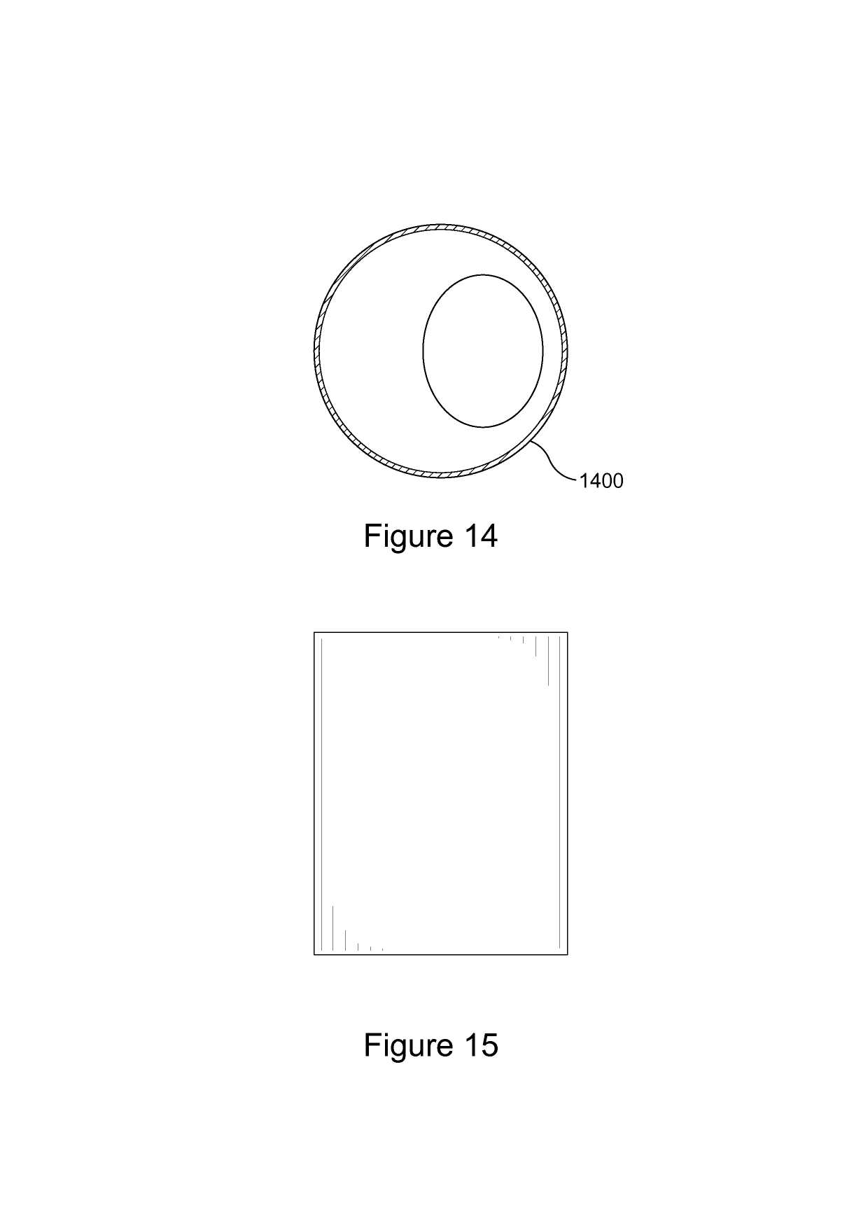

FIG. 14 illustrates a plan view of the head box device 1400 of the present invention which may have a cross-section of a circle.

FIG. 15 illustrates an elevation view of the head box 1400 of the present invention which may be substantially a cylinder.

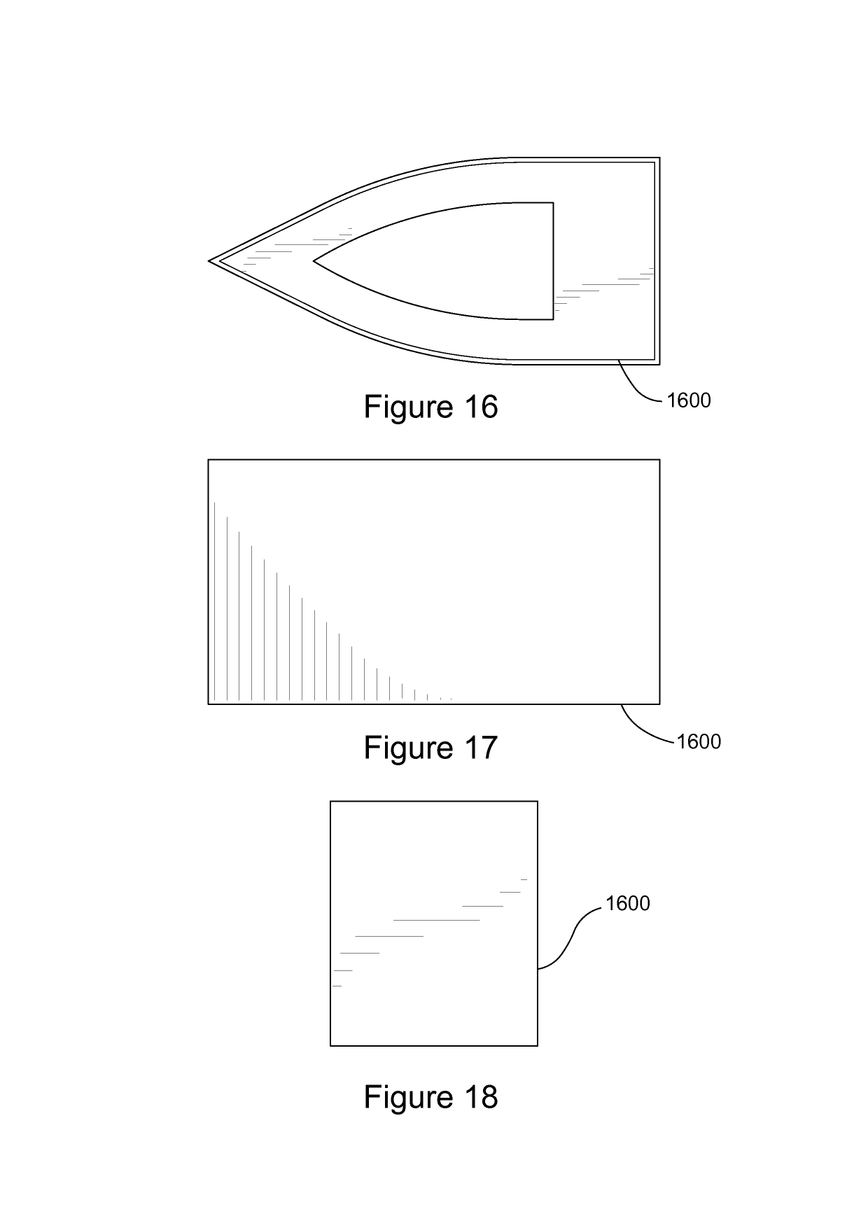

FIG. 16 illustrates a plan view of the head box device 1600 of the present invention with an ellipse flat back cross-section.

FIG. 17 illustrates a side elevation view of the head box device 1600 of the present invention.

FIG. 18 illustrates a back elevation view of the head box device 1600 of the present invention.

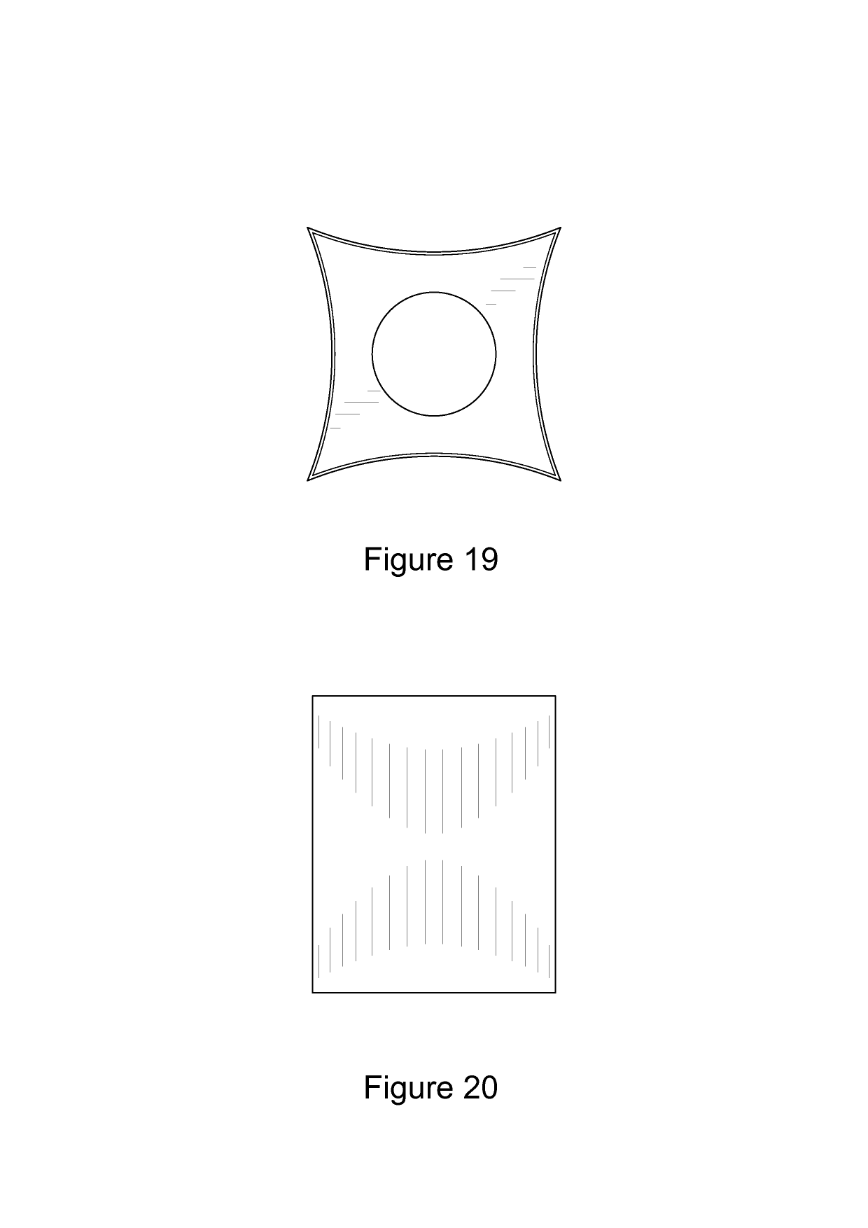

FIG. 19 illustrates a plan view of the head box device 1900 of the present invention with a free-form cross-section.

FIG. 20 illustrates a elevation view of the head box device 1900 of the present invention.

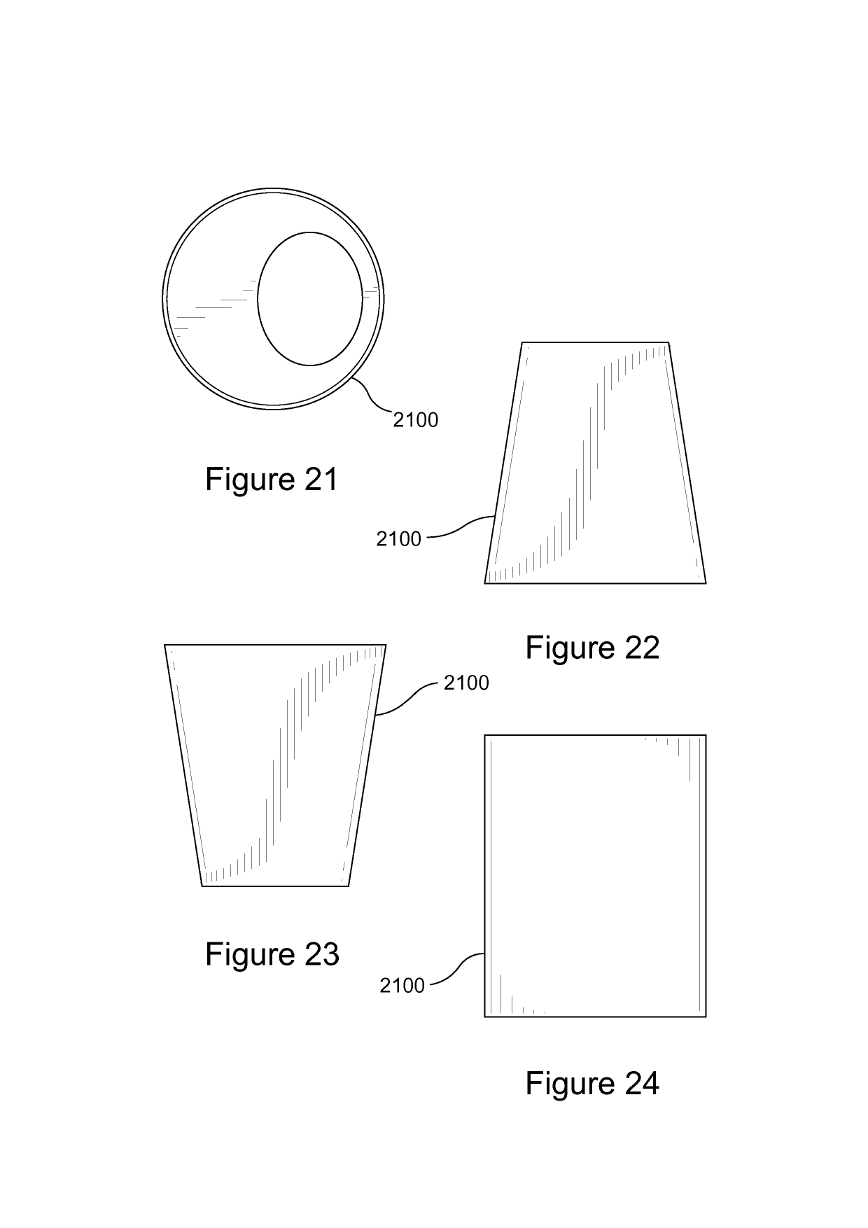

FIG. 21 illustrates a plan view of the head box device 2100 of the present invention with a circle cross section.

FIG. 22 illustrates an elevation view of the head box device 2100 of the present invention with a first elevational view.

FIG. 23 illustrates an elevation view of the head box device 2100 of the present invention with a second elevational view.

FIG. 24 illustrates a elevation view of the head box device 2100 of the present invention.

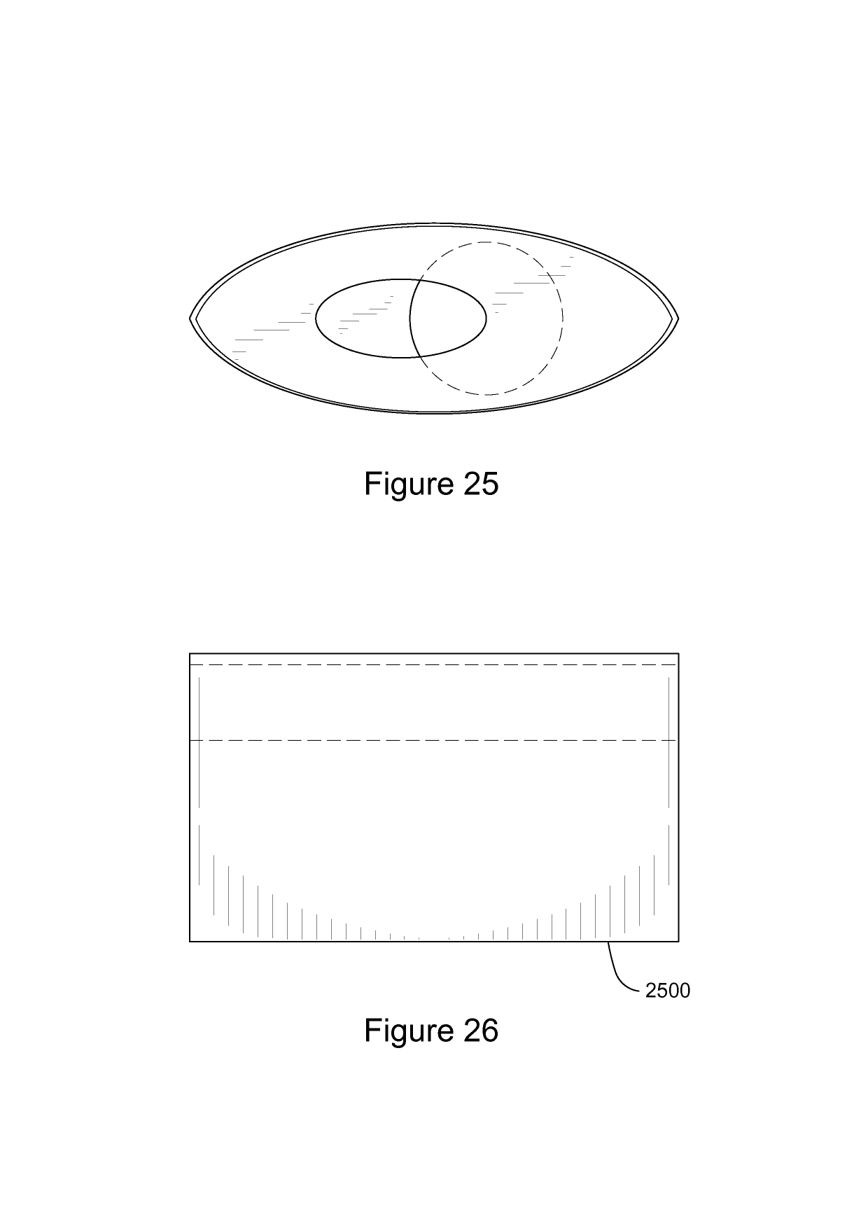

FIG. 25 illustrates a plan view of the head box device 2500 of the present invention with an ellipse shape.

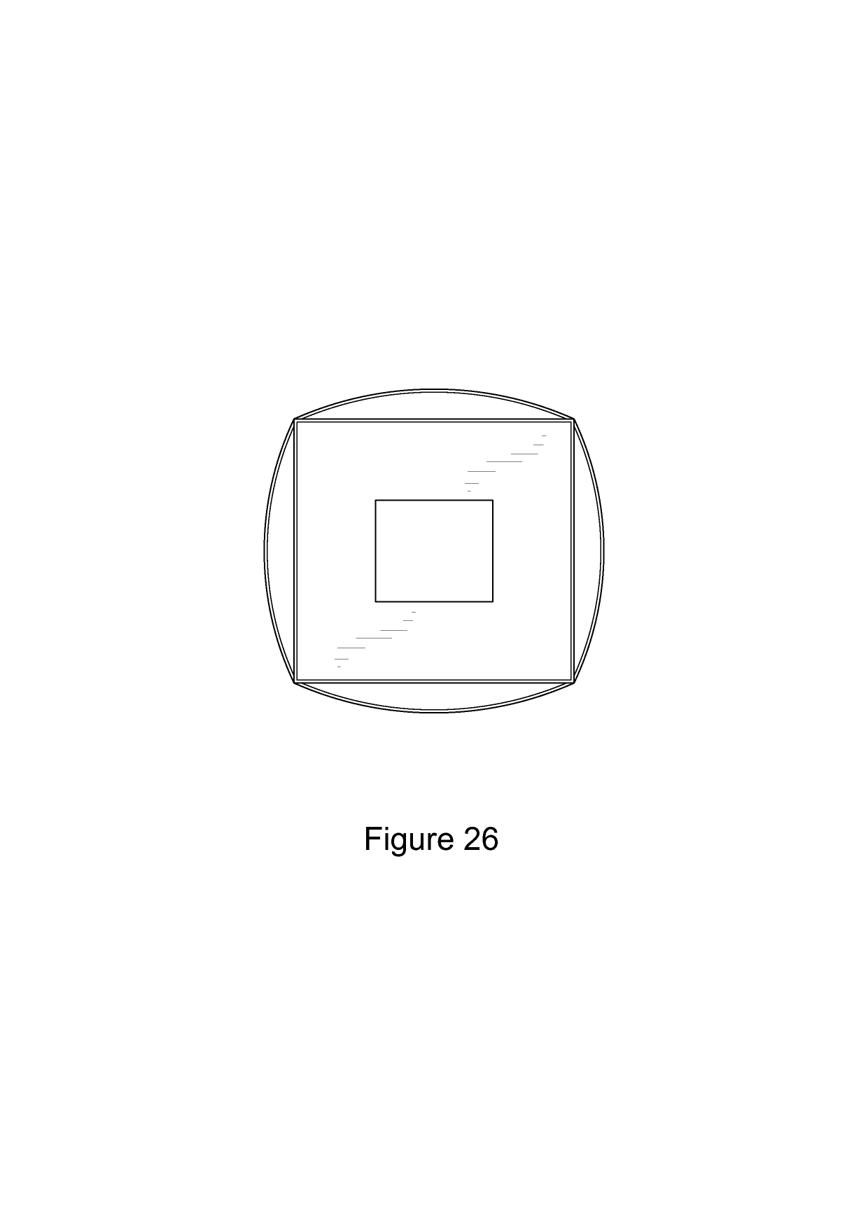

FIG. 26 illustrates an elevation view of the head box device 2500 of the present invention.

FIG. 27 illustrates a plan view of the head box device 2700 of the present invention with rectangular and curve sides.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A head box device to be worn over the head of the user, comprising:
a first sidewall;
a second sidewall which is connected to the first sidewall;
a top wall connected to the first and second sidewall;
wherein at least one of the first sidewall, second sidewall or top wall is formed from a head box material to allow a user to see through the head box device of the present invention either partially or completely and to allow indicia to be printed on the exterior surface of the head box device.

2) A head box device to be worn over the head of the user as in claim 1, wherein the head box device includes a projection device to project an image on a surface of the head box device.

3) A head box device to be worn over the head of the user as in claim 1, wherein the head box device includes a front wall being formed from a head box material to allow a user to see through the head box device of the present invention either partially or completely and to allow indicia to be printed on the exterior surface of the head box device.

4) A head box device to be worn over the head of the user as in claim 1, where in the head box device includes a back wall being formed from a head box material to allow a user to see through the head box device of the present invention either partially or completely and to allow indicia to be printed on the exterior surface of the head box device.

5) A head box device to be worn over the head of the user as in claim 1, wherein the head box device includes a circular cross-section.

6) A head box device to be worn over the head of the user as in claim 1, wherein the head box device includes a ellipse flat back cross-section.

7) A head box device to be worn over the head of the user as in claim 1, wherein the head box device includes a free-form shape cross-section.

8) A head box device to be worn over the head of the user as in claim 1, wherein the head box device includes a ellipse shape cross-section.

9) A head box device to be worn over the head of the user as in claim 1, wherein the head box device includes a rectangle curve side cross-section.
